(19) United States
(12) Patent Application Publication
(10) Pub. No.: US 2025/0246331 A1
(43) Pub. Date: Jul. 31, 2025

(54) RADIONUCLIDE PRODUCTION SYSTEM AND RADIONUCLIDE PRODUCTION METHOD

(71) Applicant: Hitachi High-Tech Corporation, Tokyo (JP)

(72) Inventors: Mizuho MAEDA, Tokyo (JP); Takahiro TADOKORO, Tokyo (JP); Yuichiro UENO, Tokyo (JP)

(21) Appl. No.: 18/854,577

(22) PCT Filed: Jan. 31, 2023
(86) PCT No.: PCT/JP2023/002988

§ 371 Date: Oct. 7, 2024

(30) Foreign Application Priority Data
Apr. 19, 2022 (JP) 2022-069060

(51) Int. Cl. G21G 1/00; G21G 1/12

(52) U.S. Cl. CPC G21G 1/001; G21G 1/12; G21G 2001/0089

(57) ABSTRACT

A radionuclide production system comprises: an electron accelerator that irradiates an electron beam; a metal target portion that generates Bremsstrahlung radiation by using the irradiated electron beam; an Ra-226 solution target portion that is irradiated by the generated Bremsstrahlung radiation, contains an Ra-226 raw material, can accommodate two or more types of solvents that phase separate, and produces Ac-225 from the Ra-226 raw material when irradiated by the Bremsstrahlung radiation; a solvent extraction part that extracts, from among the two or more types of solvents that phase separate, a first solvent containing a large amount of the Ac-225; a solvent addition part that adds the solvent of the reduced amount that was consumed to the Ra-226 solution target portion; and a radon treatment unit that treats gaseous radon generated by the Ra-226 solution target portion.

### TECHNICAL FIELD

The present invention relates to a radionuclide production system and a radionuclide production method.

### BACKGROUND ART

An internal radio isotope (RI) therapy is one of cancer treatment methods. The internal RI therapy is a treatment method in which a drug containing a radionuclide is administered to a human body, and the drug is selectively accumulated in cancer cells, and the cancer is directly irradiated with radiation to kill the cancer cells. A β-ray source is used in the internal RI therapy according to the related art, and for example, the thyroid cancer treatment using iodine-131 (I-131, ¹³¹I) has been performed since the 1940s. In recent years, an internal RI therapy using an x-ray source having a shorter range and higher linear energy transfer than a B-ray source has attracted attention because of a high therapeutic effect thereof.

Actinium-225 (Ac-225, ²²⁵Ac) is one of the therapeutic a-nuclides, and the development of a drug using Ac-225 is in progress. The production of Ac-225 is currently performed by the collapse of thorium-229 (Th-229, ²²⁹Th). Th-229 is not naturally present, and therefore, Ac-225, which is a radionuclide available for clinical use, needs to be supplied from a facility storing Th-229 at only several places in the world, and the supply amount of Ac-225 is not sufficient. With the spread of treatment using a-nuclides in the future, it is expected that the supply of Ac-225 will be significantly insufficient. Therefore, active production of Ac-225 using an accelerator is desired.

Examples of a method for producing Ac-225 using an accelerator include a cyclotron-based method in which Radium-226 (Ra-226, ²²⁶Ra) that is naturally present is used as a raw material, and the Ra-226(p, 2n)Ac-225 reaction is used (for example, see NPL 1). In this production method, there are problems such as (1) mass production cannot be performed even if Ra-226 as a target is made thicker due to the short range of accelerated protons in Ra-226 as the target, and (2) heat removal of the target is difficult because most of the energy of the accelerated protons is lost in the target, and a current value and energy cannot be reduced for mass production.

Examples of another production method using an accelerator include a method in which Ra-226 which is naturally present is used as a raw material, and Ra-226 (γ, n) Ra-225-Ac-225 reaction is used by using an electron beam accelerator. The electron beam accelerator can be downsized as compared with a proton accelerator or a heavy particle accelerator with the same acceleration energy. In addition, since the attenuation inside the target is small unlike particle beams of protons or the like, there is an advantage in mass production that the production amount does not decrease even when the raw material Ra-226 is increased.

In any of the above production methods, a step of separating and purifying Ac-225 from the Ra-226 target after radiation and collecting the raw material Ra-226 to reuse t as a radiation target is required. The Ra-226 raw material is naturally present but is not easily available, and therefore is desired to be reused. A half-life of Ra-226 is as long as 1600 years, and therefore, Ra-226 can be used semi-permanently.

A method for producing, separating and purifying Ac-225 using an accelerator is described in, for example, PTL 1. PTL 1 describes a method for purifying ²²⁵Ac (Ac-225) from a 226Ra target (Ra-226 raw material) to be irradiated with a radiation, which is provided on a support, and the method includes elution treatment of the ²²⁶Ra target using a predetermined extractant, and extraction chromatography.

### CITATION LIST

### Patent Literature

PTL 1: JP2009-527731A

### Non Patent Literature

NPL 1: C. Apostolidis, et al., Appl Radiat Isotope, (2005) 62, p 383-387

### SUMMARY OF INVENTION

### Technical Problem

The technique described in PTL 1 makes it possible to extract Ac-225 from a solid Ra-226 raw material by using dissolution and extraction chromatography. However, as in the technique described in PTL 1, the operation of extracting a sample from a solid target by dissolution, and passing, washing, and eluting the sample into an extraction chromatography resin is complicated and inefficient. In addition, radon which is a radioactive gas is generated as a daughter nuclide from the Ra-226 raw material, but operations in a closed system are required for this management, and workability (safety) is not good.

The invention has been made in view of the above circumstances. An object of the invention is to provide a radionuclide production system and a radionuclide production method by which Ac-225 can be produced simply, safely, and efficiently.

### Solution to Problem

In order to achieve the object, a radionuclide production system according to the invention includes: an electron accelerator configured to emit an electron beam; a metal target configured to generate a bremsstrahlung radiation by the emitted electron beam; an Ra-226 solution target unit to be irradiated with the generated bremsstrahlung radiation and configured to accommodate two or more kinds of solvents to be phase-separated, which contain an Ra-226 raw material, and to produce Ac-225 from the Ra-226 raw material by irradiation with the bremsstrahlung radiation; a solvent extraction unit configured to extract a first solvent containing a large amount of the Ac-225 from the two or more kinds of solvents to be phase-separated; a solvent addition unit configured to add the solvent in an amount equal to an amount of reduction for consumption to the Ra-226 solution target unit; and a radon treatment unit configured to treat gaseous radon generated in the Ra-226 solution target unit.

### Advantageous Effects of Invention

Ac-225 can be produced simply, safely, and efficiently by the radionuclide production system and the radionuclide production method according to the invention.

Problems, configurations, and effects other than those described above will become apparent from the following description of embodiments.

### BRIEF DESCRIPTION OF DRAWINGS

FIG. 1 is a schematic diagram illustrating a configuration of a radionuclide production system according to an embodiment of the invention.

FIG. 2 is a schematic diagram illustrating the configuration of the radionuclide production system according to the embodiment of the invention.

FIG. 3 is a schematic diagram illustrating the configuration of the radionuclide production system according to the embodiment of the invention.

FIG. 4 is a schematic diagram illustrating a configuration of a radionuclide production system according to an embodiment of the invention.

FIG. 5 is a flowchart illustrating contents of a radionuclide production method according to an embodiment of the invention.

### DESCRIPTION OF EMBODIMENTS

Hereinafter, a radionuclide production system and a radionuclide production method according to an embodiment of the invention will be described in detail with reference to the drawings as appropriate. In the description of the embodiments, substantially the same or similar components are denoted by the same reference signs, and a repeated description thereof may be omitted.

### (Radionuclide Production System)

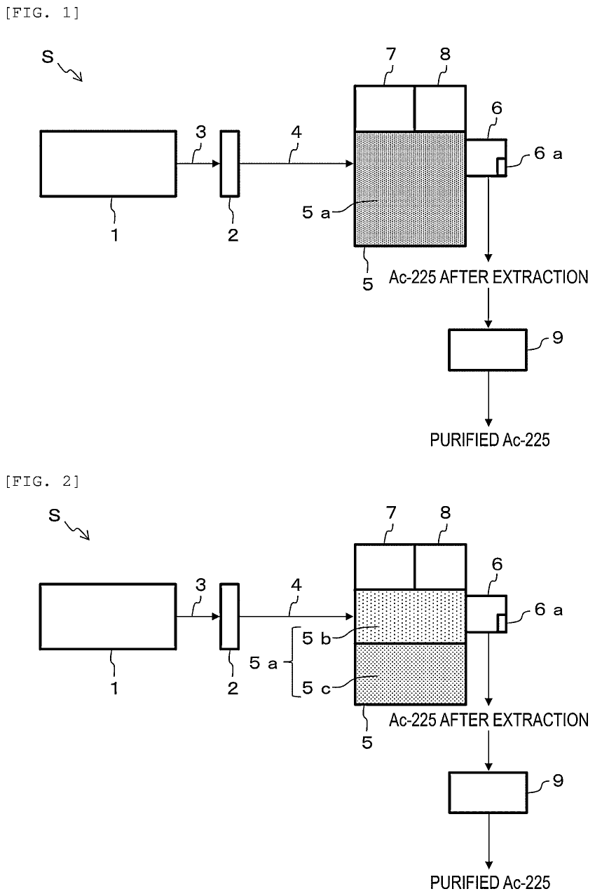

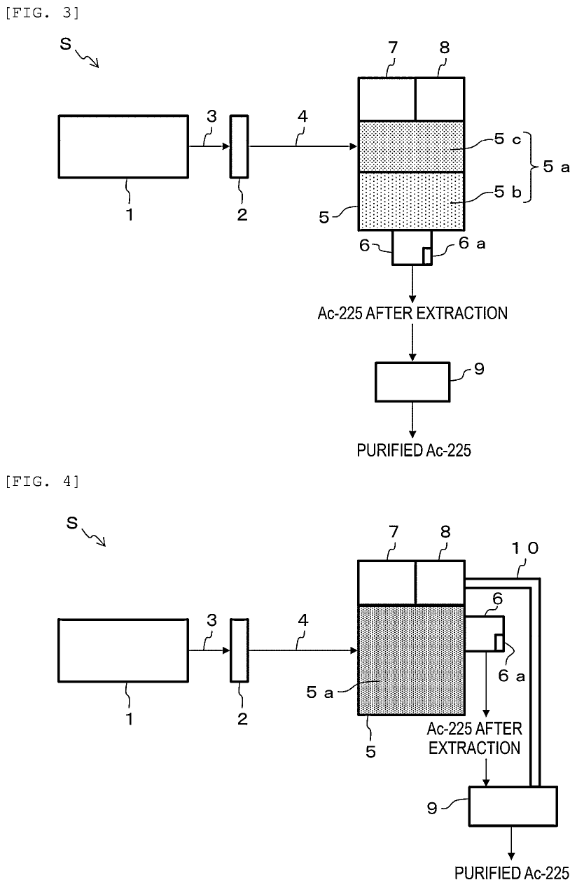

FIGS. 1 to 3 are schematic diagrams illustrating a configuration of a radionuclide production system S according to an embodiment of the invention. FIG. 1 shows a state before a solvent in an Ra-226 solution target unit 5 is phase-separated, and FIGS. 2 and 3 show states after the solvent in the Ra-226 solution target unit 5 is phase-separated. In FIGS. 2 and 3, positions of a first solvent 5b and a second solvent 5c which are phase-separated are reversed. Accordingly, a position of a solvent extraction unit 6 is also changed.

As shown in FIGS. 1 to 3, the radionuclide production system S according to the present embodiment includes an electron accelerator 1, a metal target 2, the Ra-226 solution target unit 5, the solvent extraction unit 6, a radon treatment unit 7, and a solvent addition unit 8. The electron accelerator 1, the metal target 2, and the Ra-226 solution target unit 5 are provided on an irradiation line (path) of an electron beam 3 (and a bremsstrahlung radiation 4). The solvent extraction unit 6, the radon treatment unit 7, and the solvent addition unit 8 are provided on the Ra-226 solution target unit 5.

The electron accelerator 1 emits the electron beam 3 to the metal target 2.

The metal target 2 generates the bremsstrahlung radiation 4 by the emitted electron beam 3.

The Ra-226 solution target unit 5 is irradiated with the generated bremsstrahlung radiation 4. Further, the Ra-226 solution target unit 5 accommodates two or more kinds of solvents to be phase-separated. This solvent contains an Ra-226 raw material. In the Ra-226 solution target unit 5, Ac-225 is produced from the Ra-226 raw material by irradiating the Ra-226 raw material contained in the solvent with the bremsstrahlung radiation 4.

The solvent extraction unit 6 extracts the first solvent 5b containing a large amount of the produced Ac-225 from two or more types of solvents to be phase-separated. The radon treatment unit 7 treats gaseous radon generated in the Ra-226 solution target unit 5.

The solvent addition unit 8 adds a solvent in an amount equal to an amount of reduction for consumption to the Ra-226 solution target unit 5.

As shown in the above configuration, the radionuclide production system S generates the bremsstrahlung radiation 4 by emitting electrons accelerated by the electron accelerator 1 to the metal target 2 which is a target for generating a bremsstrahlung radiation. In the present embodiment, Ac-225 is produced by irradiating the Ra-226 raw material with the generated bremsstrahlung radiation 4.

Production of Ac-225 from the Ra-226 raw material will be described.

First, a raw material solution for producing a radionuclide, which contains a large amount of the Ra-226 raw material, is irradiated with the bremsstrahlung radiation 4, and Ra-225 is generated by a (γ, n) reaction of generating one neutron by emission of one bremsstrahlung radiation 4 (Ra-226 (γ, n) Ra-225). Unlike a particle beam of protons or the like, the bremsstrahlung radiation 4 has a high penetrating power, so that attenuation in the solvent is small and irradiation can be performed with sufficient intensity.

The generated Ra-225 becomes Ac-225, which is a progeny nuclide, with a half-life of 14.8 days. Ac-225 becomes francium-221 (Fr-221), which is a progeny nuclide, with a half-life of 10.0 days. Fr-221 becomes astatine-217 (At-217) with a half-life of 4.9 minutes, and At-217 becomes bismuth-213 (Bi-213) with a half-life of 32 milliseconds. Ac-225 and the progeny nuclides thereof are effective for treatment, but Ra-226 and Ra-225 are nuclides unnecessary for treatment because they cause unnecessary exposure, and thus are required to be separated and purified from Ac-225. Since Ra-226, which is a raw material for radionuclide production, is valuable, it is desirable to collect and reuse Ra-226.

In addition, Ra-226 undergoes alpha decay with a half-life of 1600 years to generate Radon-222 (Rn-222) as a daughter nuclide. Rn-222 is easily diffused in the environment because Rn-222 is a gaseous radionuclide, and when Rn-222 decays with a half-life of 3.8 days, Rn-222 becomes a metallic nuclide (polonium-218 (Po-218)→lead-214 (Pb-214)→ . . . ) and adheres to various places. Nuclides that emit large amounts of radiation, such as Pb-214 and bismuth-214 (Bi-214), are present among the progeny nuclides of Rn-222, and therefore, a gas containing Rn-222 is required to be managed from the viewpoint of radiation safety. That is, a system for handling the Ra-226 raw material is a closed system, and a member for collecting and capturing Rn-222 is required to be provided in an exhaust path. Rn-222 is a rare gas, and thus it is difficult to chemically capture Rn-222. Therefore, examples of methods for capturing Rn-222 include a method of performing physical adsorption using cooled activated carbon.

It should be noted that, as a gas generated in addition to water the Rn, in solvent undergoes radiation decomposition by the bremsstrahlung radiation 4 to generate hydrogen gas and oxygen gas. In addition, water also undergoes radiation decomposition by the alpha ray emitted from the Ra-226 raw material and the progeny nuclides thereof to generate hydrogen gas and oxygen gas.

Returning to FIGS. 1 to 3, the description will be continued. As shown in FIGS. 1 to 3, the radionuclide production system S according to the present embodiment emits the electron beam 3 accelerated by the electron accelerator 1 to the metal target 2, which is a target for generating a bremsstrahlung radiation, to generate the bremsstrahlung radiation 4, and irradiates the Ra-226 solution target unit 5 containing an Ra-226 raw material. Examples of a material of the metal target 2 include heavy metals such as tungsten, platinum, and tantalum, iron, iron alloys, aluminum, aluminum alloys, copper, and copper alloys. A material of a container of the Ra-226 solution target unit 5 may be metal, glass, or resin. When the Ra-226 solution target unit 5 is made of metal, the Ra-226 solution target unit 5 can also serve as the metal target 2.

As described above, a solution target 5a accommodated in the Ra-226 solution target unit 5 contains at least two kinds of solvents to be phase-separated. Examples of the two kinds of solvents include the first solvent 5b made of an organic substance such as benzene, chloroform, alkanes, or dodecane, and the second solvent 5c such as a water solution or an acid solution. That is, the first solvent 5b is an organic solvent (nonpolar solvent), and the second solvent 5c is a polar solvent. When Ac and Ra are present in the state of ions, any one of the ions is captured using an extractant, and the solubility of Ac and Ra in an organic phase (first solvent 5b) is improved. Examples of the extractant that selectively captures Ac-225 and does not bind to Ra-226 include N, N,N′, N′-tetraoctyl diglycolamide (TODGA) and bis(2-ethylhexyl) phosphate (HDEHP). Ac-225 selectively bound to the extractant becomes nonpolar and easily dissolves in the first solvent 5b which is an organic solvent.

A large amount of the organic solvent has a specific gravity smaller than that of water, and therefore, as shown in FIG. 2, the solvents are phase-separated, in a vertical direction, into two phases including a phase located at an upper portion, which contains a large amount of Ac-225 (the first solvent 5b which is an organic solvent), and a phase located at a lower portion, which contains a large amount of the Ra-226 raw material (the second solvent 5c which is a polar solvent).

In contrast, when an organic solvent having a specific gravity larger than that of water is used, as shown in FIG. 3, the solvents are phase-separated, in a vertical direction, into two phases including a phase located at a lower portion, which contains a large amount of Ac-225 (the first solvent 5b which is an organic solvent), and a phase located at an upper portion, which contains a large amount of the Ra-226 raw material (the second solvent 5c which is a polar solvent). In the case of the mode shown in FIG. 3, the amount of Rn, generated in the second solvent 5c as the upper phase containing a large amount of Ra-226, mixed in the first solvent 5b as the lower phase containing a large amount of Ac-225 is small, and therefore, the amount of Rn mixed in the first solvent 5b as the lower phase decreases. Therefore, purification of Ac-225 after extraction performed by the solvent extraction unit 6 can be performed more safely.

The first solvent 5b containing a large amount of Ac-225 and the second solvent 5c containing a large amount of the Ra-226 raw material may have any vertical relationship, and as shown in FIGS. 2 and 3, the solvent extraction unit 6 is provided in accordance with the position of the first solvent 5b containing a large amount f Ac-225. Specifically, when the first solvent 5b containing a large amount of Ac-225 is located at the upper portion, the solvent extraction unit 6 is provided on an upper portion of a side wall of the Ra-226 solution target unit 5, as shown in FIG. 2. On the other hand, when the first solvent 5b containing a large amount of Ac-225 is located at the lower portion, the solvent extraction unit 6 is provided at a bottom portion of the Ra-226 solution target unit 5, as shown in FIG. 3.

When the first solvent 5b containing a large amount of Ac-225 is located at the upper portion, the gaseous Rn generated in the second solvent 5c containing a large amount of the Ra-226 raw material at the lower portion rises, and is mixed into the first solvent 5b containing a large amount of Ac-225. Rn is a nonpolar noble gas, and therefore has higher solubility in the organic phase (the first solvent 5b) than in the aqueous phase. In order to reduce Rn mixed in the first solvent 5b, it is preferable to provide a heating unit 6a in the solvent extraction unit 6 and lower the solubility of the gaseous Rn by heating. The heating temperature of the heating unit 6a may be several tens of degrees Celsius, for example, 50° C. to 60° C. For example, an electric heater, a gas heater, or the like may be used as the heating unit 6a, and the heating unit 6a is not limited thereto. The heating unit 6a may heat the entire solvent extraction unit 6 or may heat a part of the solvent extraction unit 6. When the Ra-226 solution target unit 5 and the solvent extraction unit 6 are connected by a hollow tube, the heating unit 6a may heat the hollow tube. The temperature of the solution target 5a is increased by the irradiation with the bremsstrahlung radiation 4, and therefore, the first solvent 5b may not be heated by the heating unit 6a when the solubility of Rn in the solvent is sufficiently low.

When the solution target 5a is irradiated with the bremsstrahlung radiation 4, Ra-225 is generated by the (γ, n) reaction with the Ra-226 raw material in the solution target 5a. Nuclides generated by other reaction paths are also present, and may not be considered here because the influence thereof in the present embodiment is small. The generated Ra-225 becomes Ac-225, which is a progeny nuclide, with a half-life of 14.8 days. When Ra-225 decays into Ac-225, Ac-225 is selectively bound to the extractant and becomes nonpolar, and transition from the second solvent 5c containing a large amount of Ra-226 to the first solvent 5b containing a large amount of Ac-225 occurs.

This transition proceeds faster as the contact area of the two kinds of solvents increases. The solution target 5a generates heat by the irradiation with the bremsstrahlung radiation 4, and therefore, the solution target 5a is stirred to some extent by convection. The separation efficiency can be increased by more actively stirring. Examples of a stirring mechanism include a method for providing a liquid conveying mechanism for circulating a solvent, a method using gas bubbling, a vibration method using a motor or the like, and a method for stirring using a rotor provided in a solvent. As the gas used for the bubbling, the gas generated during the irradiation with the bremsstrahlung radiation 4 can be circulated and used.

Rn-222 generated from the Ra-226 raw material in the solution target 5a is treated by the radon treatment unit 7 provided above the Ra-226 solution target unit 5. Examples of a method for treating Rn in the radon treatment unit 7 include adsorption with an activated carbon filter. Rn-222 has a half-life of about 3 days, but examples of the progeny nuclides include Pb-210 (half-life of 22.2 years) and Po-210 (half-life of 138 days). Therefore, Rn is managed as radioactive waste after absorption.

When the produced Ac-225 is extracted, the solution target 5a is allowed to stand still, and is phase-separated into two phases including the first solvent 5b containing a large amount of Ac-225 and the second solvent 5c containing a large amount of the Ra-226 raw material. Then, only the first solvent 5b containing a large amount of Ac-225 is extracted from the solvent extraction unit 6 (Ac-225 after extraction). As a result, Ac-225 can be obtained. During the phase separation, in order to prevent convection of the solution target 5a and accelerate the phase separation, it is preferable to stop the irradiation with the bremsstrahlung radiation 4. However, when the convection f the solution target 5a is small even during the irradiation with the bremsstrahlung radiation 4 and the influence on the phase separation is small, the irradiation with the bremsstrahlung radiation 4 may be continued. The presence or absence of occurrence and the magnitude of the convection of the solution target 5a are preferably checked in advance by a checking test. When the extractant is used, the extractant can be dissociated from Ac-225 by changing the liquid property or the type of solvents for Ac-225 after extraction.

The first solvent 5b containing a large amount of Ac-225 extracted by the solvent extraction unit 6 may contain an extractant, a small amount of the Ra-226 raw material, and the like. Therefore, it is preferable to perform additional purification by the Ac-225 purification unit 9. Accordingly, highly purified Ac-225 can be obtained (purified Ac-225). When the extractant can be dissociated from Ac-225 by purification performed by the Ac-225 purification unit 9, it is not necessary to change the liquid property or the type of solvents for the Ac-225 after extraction.

The purification performed by the Ac-225 purification unit 9 is performed by, for example, extraction chromatography, ion exchange, or solvent extraction. These may be used alone or in any combination of two or more. The extraction chromatography can be performed by using, for example, a DGA resin, an LN resin, a MnO₂ resin, an SR resin, a UTEVA resin, an RE resin, or the like manufactured by Eichrom Technologies. The ion exchange can be performed by using, for example, an AG50W resin and an AG1 resin manufactured by Biorad, or DOWEX 50W and DOWEX1 manufactured by The Dow Chemical Company. The solvent extraction in the Ac-225 purification unit 9 can be performed by a common method (solvent extraction method) performed for separating radionuclides. The extraction condition of the extraction chromatography, the condition of the ion exchange, and the extraction condition of solvent extraction in the Ac-225 purification unit 9 vary depending on the state such as the type of extractants to be used, the type of solvents, and the concentration of impurities. Such extraction of radionuclides and the like is widely performed by those skilled in the art belonging to the technical field, and therefore, they can perform the extraction without requiring excessive trial and error. At the stage of supplying to the Ac-225 purification unit 9, Ra is hardly contained in the solvent, and therefore, Rn control is unnecessary, and workability is improved.

Since the solvent and the extractant are consumed by an operation of the solvent extraction unit 6, a solvent in an amount equal to an amount of reduction for consumption is added as appropriate from the solvent addition unit 8 to the Ra-226 solution target unit 5. The solvent added from the solvent addition unit 8 is mainly the first solvent 5b, but when the second solvent 5c is reduced, the second solvent 5c can be added. An extractant can also be added by the solvent addition unit 8. Although the amount is small, Ra is separated in the Ac-225 purification unit 9, and therefore, the separated Ra may be returned to the solvent addition unit 8 as appropriate. This can be performed as follows.

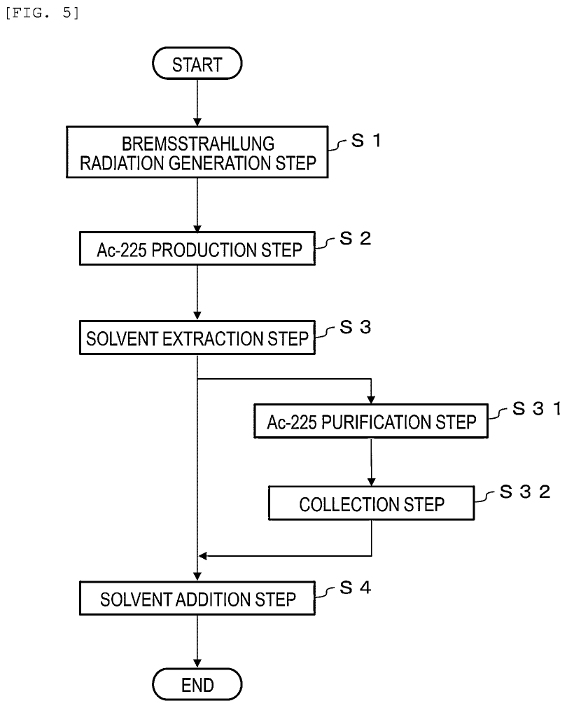

FIG. 4 is a schematic diagram illustrating a configuration of the radionuclide production system S according to an embodiment of the invention. As shown in FIG. 4, the radionuclide production system S may include a collection unit 10 between the Ac-225 purification unit 9 and the solvent addition unit 8. The collection unit 10 collects a small amount of the Ra-226 raw material and the first solvent 5b containing a large amount of Ac-225, which are obtained when the Ac-225 is purified in the Ac-225 purification unit 9, and returns them to the solvent addition unit 8. The collected first solvent 5b contains the extractant t collected during the purification, and therefore, the collection unit 10 returns the first solvent 5b and the extractant to the solvent addition unit 8. That is, the collection unit 10 functions as a reuse mechanism of the Ra-226 raw material, the first solvent 5b, and the extractant. Accordingly, radioactive waste can be reduced, and the valuable Ra-226 raw material can be easily reused. The collection unit 10 can include, for example, a flexible hollow tube connecting the Ac-225 purification unit 9 and the solvent addition unit 8, and a pressure application device (not shown) such as a diaphragm pump provided in the middle of the flexible hollow tube, but is not limited to this mode as long as the first solvent 5b and the extractant can return from the Ac-225 purification unit 9 to the solvent addition unit 8.

### (Radionuclide Production Method)

Next, a radionuclide production method according to an embodiment of the present invention will be described with reference to FIG. 5. FIG. 5 is a flowchart illustrating contents of the radionuclide production method according to the embodiment of the invention.

As shown in FIG. 5, the radionuclide production method according to the present embodiment includes a bremsstrahlung radiation generation step S1, an Ac-225 production step S2, a solvent extraction step S3, and a solvent addition step S4.

The present radionuclide production method may further include an Ac-225 purification step S31 after the solvent extraction step S3.

The present radionuclide production method may further include a collection step S32 after the Ac-225 purification step S31.

Hereinafter, these steps will be described.

In the bremsstrahlung radiation generation step S1, the electron beam 3 is emitted from the electron accelerator 1 to the metal target 2 to generate the bremsstrahlung radiation 4 from the metal target 2. This step can be performed by the electron accelerator 1 and the metal target 2 described above.

In the Ac-225 production step S2, the solvents accommodated in the Ra-226 solution target unit 5 (that is, two or more kinds of solvents to be phrase-separated, which contain the Ra-226 raw material) are irradiated with the generated bremsstrahlung radiation 4 to produce Ac-225 from the Ra-226 raw material, and the generated gaseous radon is treated. This step can be performed by the Ra-226 solution target unit 5 described above. The treatment of the gaseous radon can be performed by the radon treatment unit 7 described above.

In the solvent extraction step S3, the first solvent 5b containing a large amount of Ac-225 is extracted from the two or more kinds of solvents to be phase-separated. This step can be performed by the solvent extraction unit 6 described above.

In the solvent addition step S4, a solvent in an amount equal to an amount of reduction for consumption is added to the Ra-226 solution target unit 5. This step can be performed by the solvent addition unit 8 described above.

In the Ac-225 purification step S31, Ac-225 is purified from the first solvent 5b extracted in the solvent extraction step S3 and containing a large amount of Ac-225. This step can be performed by the Ac-225 purification unit 9 described above.

In the collection step S32, the Ra-226 raw material and the first solvent 5b containing a large amount of Ac-225 which are obtained when Ac-225 is purified in the Ac-225 purification step S31 are collected and returned to the solvent addition step S4. This step can be performed by the collection unit 10 described above.

As described above, the radionuclide production system S and the radionuclide production method according to the present embodiment can easily and efficiently produce Ac-225 because separation of Ra/Ac can be performed simultaneously with irradiation with the bremsstrahlung radiation 4. In addition, the radionuclide production system S and the radionuclide production method according to the present embodiment can safely produce Ac-225 because Rn can be treated by operating in a closed system during production of Ac-225.

The radionuclide production system and the radionuclide production method according to the invention are described in detail above in the embodiments, but the invention is not limited to the above embodiments, and includes various modifications. For example, the above embodiments are described in detail to facilitate understanding of the invention, and the invention is not necessarily limited to those including all the configurations described above. A part of a configuration of a certain embodiment can be replaced with a configuration of another embodiment, and a configuration of another embodiment can be added to a configuration of a certain embodiment. A part of a configuration according to each embodiment may be deleted, added with, or replaced with another configuration.

### REFERENCE SIGNS LIST

S: radionuclide production system
1: electron accelerator
2: metal target
3: electron beam
4: bremsstrahlung radiation
5: Ra-226 solution target unit
5a: solution target
5b: first solvent
5c: second solvent
6: solvent extraction unit
6a: heating unit
7: radon treatment unit
8: solvent addition unit
9: Ac-225 purification unit
10: collection unit
S1: bremsstrahlung radiation generation step
S2: Ac-225 production step
S3: solvent extraction step
S31: Ac-225 purification step
S32: collection step
S4: solvent addition step

1. A radionuclide production system comprising:
an electron accelerator configured to emit an electron beam;
a metal target configured to generate a bremsstrahlung radiation by the emitted electron beam;
an Ra-226 solution target unit to be irradiated with the generated bremsstrahlung radiation and configured to accommodate two or more kinds of solvents to be phase-separated, which contain an Ra-226 raw material, and to produce Ac-225 from the Ra-226 raw material by irradiation with the bremsstrahlung radiation;
a solvent extraction unit configured to extract a first solvent containing a large amount of the Ac-225 from the two or more kinds of solvents to be phase-separated;
a solvent addition unit configured to add the solvent in an amount equal to an amount of reduction for consumption to the Ra-226 solution target unit; and
a radon treatment unit configured to treat gaseous radon generated in the Ra-226 solution target unit.

2. The radionuclide production system according to claim 1, wherein
the Ra-226 solution target unit includes a stirrer configured to mix the two or more kinds of solvents to be phase-separated.

3. The radionuclide production system according to claim 1, wherein
the solvent extraction unit includes a heating unit configured to heat the first solvent containing the large amount of Ac-225.

4. The radionuclide production system according to claim 1, wherein
the two or more kinds of solvents to be phase-separated include an organic solvent as the first solvent and a polar solvent as a second solvent, and contain an extractant having a property of selectively binding to the Ac-225.

5. The radionuclide production system according to claim 1, further comprising
an Ac-225 purification unit configured to purify the Ac-225 from the first solvent extracted by the solvent extraction unit and containing the large amount of Ac-225.

6. The radionuclide production system according to claim 5, further comprising:
a collection unit between the Ac-225 purification unit and the solvent addition unit, configured to collect the Ra-226 raw material and the first solvent containing the large amount of Ac-225, which are obtained when the Ac-225 is purified in the Ac-225 purification unit, and configured to return the collected Ra-226 raw material and first solvent to the solvent addition unit.

7. The radionuclide production system according to claim 1, wherein
the radon treatment unit includes an adsorbent configured to adsorb the gaseous radon.

8. The radionuclide production system according to claim 1, wherein
for the two or more kinds of solvents to be phase-separated, the second solvent containing a large amount of the Ra-226 raw material is located at an upper portion in a vertical direction, and the first solvent containing the large amount of Ac-225 is located at a lower portion in the vertical direction during the phase separation.

9. A radionuclide production method comprising:
a bremsstrahlung radiation generation step of emitting an electron beam from an electron accelerator to a metal target to generate a bremsstrahlung radiation from the metal target;
an Ac-225 production step of irradiating two or more kinds of solvents to be phase-separated, which are accommodated in an Ra-226 solution target unit and contain an Ra-226 raw material, with the generated bremsstrahlung radiation to produce Ac-225 from the Ra-226 raw material, and treating generated gaseous radon;
a solvent extraction step of extracting a first solvent containing a large amount of the Ac-225 from the two or more kinds of solvents to be phase-separated; and
a solvent addition step of adding the solvent in an amount equal to an amount of reduction for consumption to the Ra-226 solution target unit.

10. The radionuclide production method according to claim 9, further comprising:
after the solvent extraction step, an Ac-225 purification step of purifying the Ac-225 from the first solvent extracted in the solvent extraction step and containing the large amount of Ac-225.

11. The radionuclide production method according to claim 10, further comprising:
after the Ac-225 purification step, a collection step of collecting the Ra-226 raw material and the first solvent containing the large amount of Ac-225, which are obtained when the Ac-225 is purified in the Ac-225 purification step, and returning the collected Ra-226 raw material and first solvent to the solvent addition step.
